(19) United States
(12) Patent Application Publication
(10) Pub. No.: US 2006/0028717 A1
(43) Pub. Date: Feb. 9, 2006

(54) Network memory microscope

(76) Inventor: Steven M. Dunn, Leawood, KS (US)

Correspondence Address: Hovey Williams LLP, Suite 400, 2405 Grand Blvd., Kansas City, MO, 64108, US

(21) Appl. No.: 10/911,329

(22) Filed: Aug. 4, 2004

(51) Int. Cl. G02B 21/00

(52) U.S. Cl. 359/368; 359/363

(57) ABSTRACT

A microscope (10) with the circuitry (40) and internal memory (46) for recording and storing magnified images for later retrieval and viewing. The microscope includes a stand (12), a stage (20) supported by the stand for holding a specimen to be viewed, a lens assembly (30, 34) for providing a magnified view of the specimen on the stage, and image capture circuitry (40) for creating an image signal representative of the magnified view of the specimen. The image capture circuitry (40) includes memory for storing the image signal for subsequent retrieval and display. The microscope also includes a computing device with its own Internet protocol address that permits remote computers to access and view images taken by the microscope via a communications network such as the Internet.

### BACKGROUND OF THE INVENTION

1. Field of the Invention

The present invention relates to microscopes and related instruments. More particularly, the invention relates to a microscope with circuitry and internal memory for recording and storing magnified images for later retrieval and viewing and with network capabilities that permit remote computers to access the microscope via a network and view the magnified images.

2. Description of the Prior Art

Microscopes with conventional objective lenses are commonly used in laboratories, classrooms, and other applications for providing magnified viewing of specimens. Video microscope devices which use cameras rather than microscope lenses are also commonly used to allow educators, scientists, business people, and others to capture video images of objects and display the video images on TV monitors so that students and others may view magnified images of the objects. Video microscopes improve lectures, demonstrations, and experiments by allowing many people to see the same magnified image. Because they are portable and easy to connect to a standard TV monitor, they can be used in almost any application where it is desirable to magnify and display a video image of an object.

Microscope and video microscope users often desire to record magnified images for subsequent retrieval and viewing. For example, users often desire to record an image of a specimen and then later compare it to a “live” image of the same specimen to see changes that have occurred to the specimen overtime. Similarly, users often desire to record an image of a specimen taken at a certain level of magnification and then compare it to an image of the same specimen taken at a different level of magnification.

Unfortunately, existing microscopes and video microscopes are not capable of recording and storing images of specimens. Therefore, these devices must be coupled with video cassette recorders (VCRs) or other recording devices in order to record and store images. Those skilled in the art will appreciate that connecting a microscope or video microscope to a VCR or other recording device is cumbersome and time consuming and requires multiple pieces of equipment and the associated cabling to connect the equipment. This limits the practicality and use of the devices.

Users also often wish to view magnified images on remote computers. To do so currently, a video microscope must be connected to remote computers via cabling so that images may be transferred from the microscope to the computers. Cabling and signal propagation limitations require that the computer be placed in the general vicinity of the microscope. Use of cabling also limits the number of computers that can be connected to a video microscope to just a few.

To permit magnified images to be viewed by computers that are more remotely positioned from a video microscope and to permit more computers to access the images, a video microscope can be cabled to a separate computer which is, in turn, connected to a network such as the Internet. This permits many remote computers to access and view images that have been transferred from the video microscope to the computer. However, this requires a separate computer, cabling to connect the computer to the microscope, and software on the computer for permitting uploading and reviewing of the images. Such additional hardware and software requirements are not practical for many applications.

### SUMMARY OF THE INVENTION

The present invention solves the above-described problems and provides a distinct advance in the art of microscopes. More particularly, the present invention provides a microscope with circuitry and internal memory for creating, recording and storing magnified images of specimens for subsequent retrieval and viewing. The present invention also provides a microscope with network capabilities that permits stored images to be accessed and viewed by remote computers without requiring the microscope to be first connected to a separate computer.

One embodiment of the present invention provides a microscope including a stand; a stage supported by the stand for holding a specimen to be viewed; a lens assembly for providing a magnified view of the specimen on the stage; and image capture circuitry for creating an image signal representative of the magnified view of the specimen. The image capture circuitry includes memory for storing the image signal for subsequent retrieval and display. The memory may include a hard drive, an EPROM chip, or other memory device permanently located in the microscope, but preferably consists of a removable memory card and associated memory slot formed in the microscope stand. The memory card and slot preferably are compact flash or secured digital devices.

Another embodiment of the invention provides a video microscope including a base; an elongated flexible neck extending upwardly from the base; a camera mounted on the neck for capturing an image of a specimen and for creating a corresponding image signal; and image capture circuitry coupled with the camera and including memory for storing the image signal for subsequent retrieval and display. As with the previous embodiment of the invention, the memory may include a hard drive, an EPROM chip, or a removable memory card and associated memory slot formed in the microscope stand. In preferred forms, the memory is a removable compact flash or secured digital memory card and associated memory slot.

The image capture circuitry of both embodiments may also include a controller or processor coupled with the memory and a plurality of outputs for permitting stored images to be output to external devices. The image capture circuitry may also include controls coupled with the controller for permitting a user to control the functions of the microscope and video microscope as described below.

In use, the microscope and video microscope of the present invention permit a user to record and store images for subsequent retrieval and viewing on a computer monitor or TV. The image capture circuitry provides various display options such as a Dual Screen Mode where a previously recorded image can be shown alongside a currently viewed or “live” image; a Full Screen Mode where either a previously recorded image or “live” image is displayed; a Picture-in-Picture Screen Mode where a previously recorded image can be shown and a live image can be shown inside a small box superimposed over the previously recorded image (or vice versa); and a Quad Screen Mode where four images can be simultaneously shown (for example three previously recorded images and a live image). The memory preferably has 8 or more Megabytes of storage capacity for simultaneously storing at least 30 images, but may be sized for storing any number of images.

The image capture circuitry may include a Manual Record Mode in which a user manually initiates recording of an image and an Auto Record Mode in which images are automatically recorded and stored according to a predetermined time interval. For example, the Auto Mode may be set to automatically record images every 1-60 seconds. The user may select between the Manual and Auto Modes and select the time interval for automatic recording with the controls.

In another embodiment of the invention, the microscope's controller or processor is provided with its own unique Internet protocol address and software that permits it to be connected to the Internet. A network connector such as an RJ45 jack is coupled with the controller/processor and may be coupled with a corresponding wall jack with a suitable connector. This permits the controller or processor to be accessed by multiple remote computers over a network such as the Internet or any other conventional communications network. Anyone with a computer that is connected to the Internet or other communications network may type in the Internet protocol address of the microscope and access and view images stored in the memory of the microscope. The controller or processor is also preferably encoded with a viewer program which permits remote computers to control the microscope to record and store additional magnified images and to perform other control functions.

These and other important aspects of the present invention are described more fully in the detailed description below.

### BRIEF DESCRIPTION OF THE DRAWING FIGURES

Preferred embodiments of the present invention are described in detail below with reference to the attached drawing figures, wherein:

FIG. 1 is a perspective view of a microscope constructed in accordance with a preferred embodiment of the present invention.

FIG. 2 is a rear elevational view of the microscope of FIG. 1.

FIG. 3 is a block diagram illustrating the image capture circuitry of the microscope shown coupled with the lenses of the microscope.

FIG. 4 is a perspective view of a video microscope constructed in accordance with another preferred embodiment of the invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

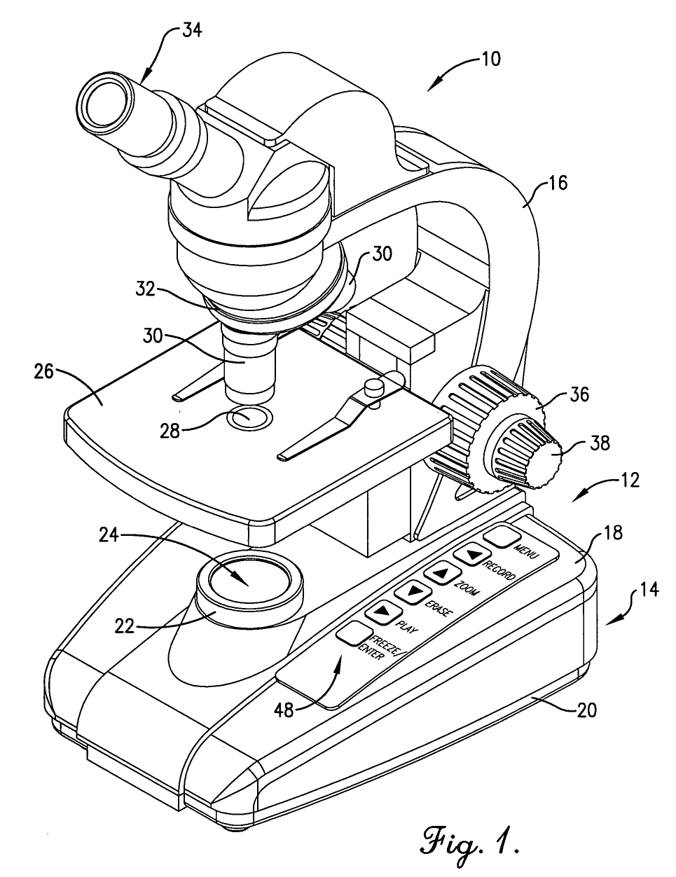

Turning now to the drawing figures, and particularly FIG. 1, a microscope 10 constructed in accordance with a preferred embodiment of the invention is illustrated. The microscope 10 has many of the same components as conventional microscopes such as the T-1201 and T-1901 model microscopes manufactured and sold by Ken-A-Vision Manufacturing Co., Inc., of Kansas City, Mo. For example, the microscope 10 preferably includes a conventional stand 12 having a base 14 which may be placed on a counter top or other level surface and an upstanding arm 16 supported on the base 14. The base 14 includes an upper section 18 and a lower section 20 that are removably connected with screws or other conventional fasteners. The upper section 18 has a raised circular lamp holder 22 for receiving a light source 24. The top of the lamp holder 22 defines a circular opening for directing light from the light source 24 upwardly.

The microscope 10 also includes a stage 26 supported by the arm 16 for holding specimens to be viewed. The stage 26 includes an opening 28 in approximate axial alignment with the light source 24. As is conventional, specimens are placed on the stage 26 over the opening 28 so that light may pass through the specimens.

The microscope also includes a lens assembly including one or more objective lenses 30 supported on the arm 16 above the stage 26 for magnifying specimens placed on the stage 26. The objective lenses 30 may be mounted on a rotatable head 32 or carousel that allows certain ones of the lenses 30 to be selected for use.

The lens assembly also includes one or more eyepiece lenses 34 mounted on the arm 30 above the objective lenses 28 for providing further magnification of specimens and for permitting a user to view the images. The eyepiece lenses 34 may also be mounted to a rotating head or carousel. The microscope 10 also includes conventional controls mounted to the stand 12 such as course and fine coaxial focusing knobs 36, 38.

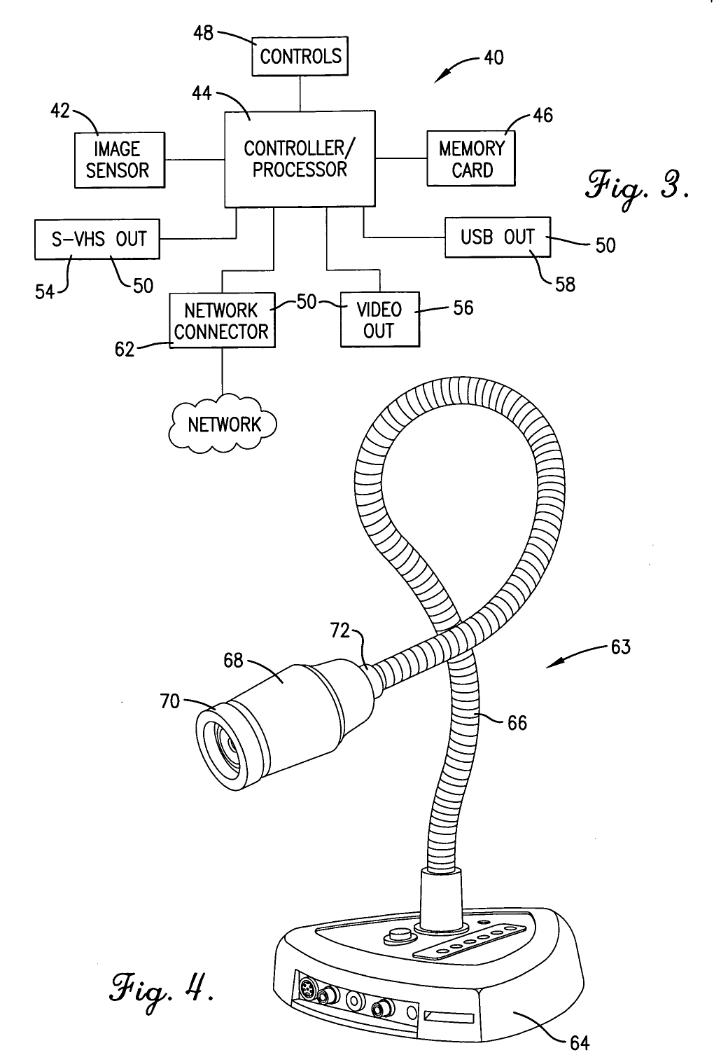

In accordance with one important aspect of the present invention, the microscope 10 also includes image capture circuitry 40 illustrated in FIG. 3 for recording and storing images for subsequent retrieval and display. The image capture circuitry broadly includes an image sensor 42, a controller, processor or other computing device 44, memory 46, controls 48, and a plurality of outputs 50.

The image sensor 42 is configured for sensing magnified views of specimens viewed by the lenses 30, 34 and for generating corresponding image signals. The image sensor 42 is preferably similar to image sensors found in CCD cameras, but may utilize other sensor conventional sensor technology.

The controller/processor 44 is coupled with the image sensor 42 for receiving the image signals therefrom. The controller/processor 44 may be any computing device, but is preferably part of an application specific integrated circuit (ASIC). The image sensor 42 and the controller/processor 44 may be separate components as illustrated or may be integrated into a single ASIC or other component. Certain functions of the controller/processor are described in more detail below.

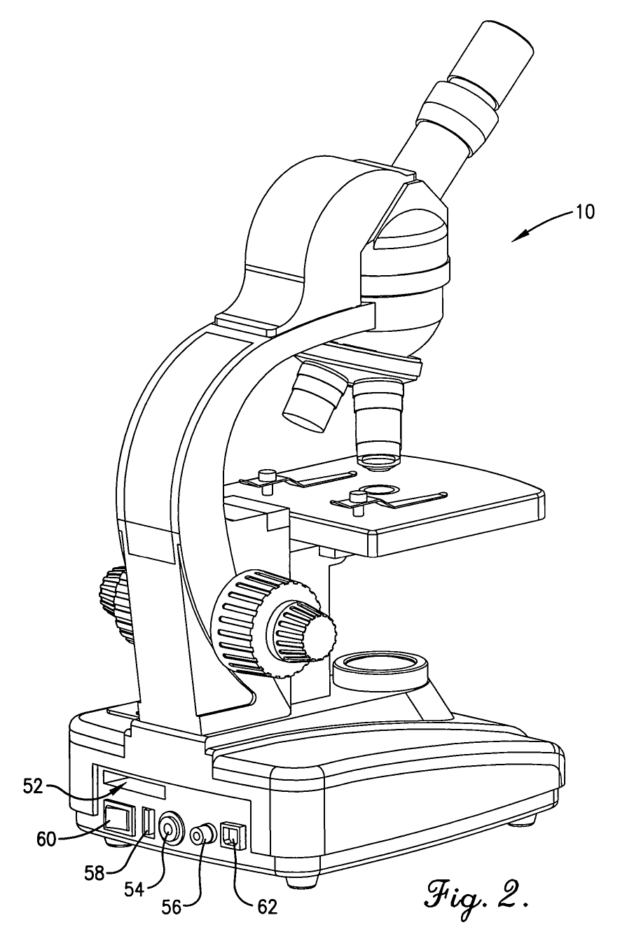

The memory 46 is coupled with the controller/processor 44 and is configured for storing the image signals for subsequent retrieval and display. The memory 46 preferably stores the image signals as JPEG files, but may utilize other storage standards. The memory 46 may consist of a hard drive, EPROM chip, or other memory device which permanently resides in the microscope. However, the memory 46 preferably comprises a removable compact flash or secured digital memory card that is received within a corresponding memory slot 52 formed in the base 14 of the microscope 10 as best illustrated in FIG. 2. This permits the memory card to be easily removed from the microscope and then coupled with a computer or other device for use in displaying the images stored on the memory card.

The controls 48 are coupled with the controller/processor 44 for permitting user control of the various functions of the image capture circuitry as described in more detail below. As illustrated in FIG. 1, the controls are preferably in the form of a keypad having individual buttons for MENU, RECORD, ZOOM, ERASE, PLAY, FREEZE/ENTER. Operation of these individual buttons is described below.

The outputs 50 are coupled with the controller/processor 44 and permit output of image signals to a TV monitor, a computer monitor or other display device. As described in more detail below, the controller/processor 44 and outputs 50 may be used to output “live” image signals or pre-recorded image signals recorded and stored in the memory 46. As illustrated in FIGS. 2 and 3, in preferred forms, three outputs are provided: an SNHS analog output 54, a conventional analog video output 56, and a digital universal serial bus (USB) output 58. The analog outputs 54, 56 are configured for coupling with an analog monitor such as a television, and the digital output 58 is configured for coupling with a computer or digital display such as a computer monitor.

The image capture circuitry 40 and the light source 24 may be powered by a battery (not shown) mounted in the base 14 or by alternating current provided by a conventional 120-volt AC wall outlet. A conventional on/off switch 60 is illustrated in FIG. 2 for switching power between the battery or the wall outlet and the image capture circuitry 40 and the light source 24.

Because memory components are susceptible to failure when exposed to high heat, the light source 24 preferably utilizes LED technology rather than conventional fluorescent, halogen, or tungsten light bulbs which generate excess heat. The preferred light source is described in U.S. Pat. No. 6,714,348; hereby incorporated into the present application by reference. The light source broadly includes a circuit board and one or more LEDs mounted on the circuit board.

The circuit board is preferably a conventional printed circuit board that is cut or formed so that it fits snugly within the lamp holder 22. The top surface of the circuit board is coated with a highly reflective material such as tin to reflect light emitted from the LEDs upwardly toward a specimen placed over the opening 28 in the stage 26. A 28 mm white frosted filter is preferably positioned in the top of the lamp holder 22 to filter the light emitted from the LEDs toward the stage 26.

The LEDs are arranged on the top surface of the circuit board so as to project light upwardly toward the stage 26. In preferred forms, the light source includes four LEDs positioned in the approximate center of the circuit board and arranged in a substantially Y-shaped configuration.

The LEDs have special operating characteristics that enhance and optimize the light output of the microscope. For example, the LEDs have a highly-focused angle of illumination so that most of their generated light is projected upwardly toward the stage 26, rather than sideways or down toward the circuit board. It has been determined that the optimum angle of illumination is approximately 20 degrees. Moreover, the LEDs emit a true white light, rather than a blue light as is conventional with LEDs, that provides superior sample illumination for microscopic applications. Further, each LED provides over 5,000 millicandellas (MCD) of illumination, but operates at a temperature less than 25 degrees C. Finally, each LED has a bulb life of approximately 100,000 hours. The preferred LEDs are supercool-white InGaN discrete model number L200CWGKB-22D LEDs manufactured by Ledtronics.

Because the LEDs are arranged on a reflective coated circuit board, have a highly-focused angle of illumination, operate at a high candle power, and generate optimum true white light, the light source provides illumination equivalent to a 20-watt bulb. Advantageously, however, the light source 24 requires much less power than a conventional 20-watt bulb and operates at a much lower temperature. The light source 24 therefore needs no cooling fan and can be powered by a small battery.

If any of the LEDs burn out, the entire light source 24 can be easily removed and replaced with a new light source. Because the LEDs and all other circuitry are mounted to the circuit board, no further modifications are required to replace the light source.

The image capture circuitry 40 provides various display options such as a Dual Screen Mode where a previously recorded image can be shown alongside a currently viewed or “live” image; a Full Screen Mode where either a previously recorded image or a live image is displayed; a Picture-in-Picture Screen Mode where a previously recorded image can be displayed and a live image can be shown inside a small box superimposed over the previously recorded image (or vice versa); and a Quad Screen Mode where four images can be simultaneously shown (for example three previously recorded images and a live image). The memory preferably has 8 or more Megabytes of storage capacity for simultaneously storing at least 30 images but may be sized for storing any number of images. A user can select between these display modes with the controls as described below.

The image capture circuitry 40 also provides several recording options. In a Manual Record Mode, a user manually initiates recording of an image. In an Auto Record Mode, images are automatically recorded and stored according to a pre-selected time interval. For example, the Auto Record Mode may be set to automatically record images every 1-60 seconds. The user may select between the Manual Record Mode and Auto Record Mode and select the time interval for automatic recording with the controls as discussed below.

In use, the microscope 10 is first connected to a power supply and turned on. The output ports 50 are then connected to appropriate cabling which is in turn connected to a TV, computer and/or computer monitor. A specimen is then placed on the stage 26 and viewed in a conventional manner. At this point a user may begin to display and record images.

The controller/processor 44 and controls 48 may be configured in many different ways to switch between and enable the above-described display options and recording options. In one example, a user may select the desired display option by pushing the MENU button. Consecutive pushes changes the controller from Full Screen Mode, Dual Screen Mode, Quad Screen Mode, and Picture-In-Picture Screen Mode.

Once the display mode is selected, the user may begin to record and store images. To record an image in the Manual Record Mode, the user simply presses the RECORD button. This triggers the image capture circuitry 40 to record and store an image of the specimen currently being viewed. If the Split Screen Mode was selected above, the left side of the monitor preferably displays a live image of the specimen whereas the right side of the monitor displays the recorded image. Multiple recorded images stored in the memory may be cycled through and displayed by successively pushing the PLAY button.

If the Quad Screen Mode was selected above, the upper left portion of the monitor preferably shows the live image whereas the other three portions of the display show previously stored images. The user may cycle between additional stored images by successively pushing the PLAY button.

If the Full Screen Mode was selected above, the display initially displays only live images. The user may instead cycle between and display successively stored images by pushing the PLAY button.

In all display modes, the ERASE button may be pushed at any time to delete a displayed image from memory.

The ZOOM button may be pushed to select a particular portion of a displayed image to enlarge. When the ZOOM button is pushed, a square is superimposed on the display. The square may be moved anywhere on the image by using any of the four arrows shown on the control buttons. Once the square has been moved over to the area that the user wishes to enlarge, the user pushes the FREEZE/ENTER button to zoom or enlarge the selected area.

To select the Auto Record Mode, the user presses the MENU button for three seconds and uses the arrows to scroll to this mode. Once in the Auto Record Mode, the user first selects the recording interval as described above and then pushes the RECORD button. The image capture circuitry then begins automatically recording and storing images according to the selected time interval. To stop recording, the user simply pushes the RECORD button again.

The above are only some examples of how the controller/processor 44 may be programmed to allow a user to record and store images for immediate or later retrieval and display. Those skilled in the art will appreciate that the control options for the controller/processor 44 are nearly endless.

Another embodiment of the present invention is illustrated in FIG. 4. In this embodiment, a video microscope 62 is provided which broadly includes a base 64; an elongated flexible neck 66 extending upwardly from the base; a camera 68 mounted on the neck for capturing an image of a specimen and for creating a corresponding image signal; and image capture circuitry coupled with the camera.

The camera 68 may be any conventional camera such as the ones used with the Video Flex line of video microscopes sold by Ken-A-Vision Manufacturing Company, Inc. The camera is preferably coupled with an 8 mm lens assembly 70 that permits magnification of the video image. The lens is C-mounted so that it is removable, allowing it to be replaced with other lenses. Conventional focusing mechanism may be connected to the lens.

The camera 68 and lens 70 are preferably mounted to the end of the elongated flexible neck 66 by a ball and socket head 72. The flexible neck, base, and ball and socket head together permit the camera to be quickly and easily positioned to nearly any orientation so that it may be used to capture video images of nearly any object. The flexible neck, base, and ball and socket head are preferably the same as the components provided on the Video Flex line of video microscopes manufactured and sold by Ken-A-Vision Manufacturing Company, Inc.

The image capture circuitry of the video microscope 62 is similar to the image capture circuitry 40 described above. The image capture circuitry of the video microscope 62 differs in that the functions of the image sensor 42 may be incorporated into the camera. Thus, the image circuitry of the video microscope 62 may only include a controller, memory, controls, and a plurality of outputs. Operation of the video microscope to record and store images is the same as the operation of the microscope 10 described above.

In another embodiment of the invention, the controller/processor 44 is provided with its own unique Internet protocol address and is encoded with software that permits it to be accessed via the Internet or other communications network. A network connector 62 such as an RJ45 jack is positioned on the base 14. The connector 62 is coupled with the controller/processor 44 and may be coupled with a corresponding wall jack with a suitable connector. This permits the controller/processor 44 to be accessed by multiple remote computers over a network such as the Internet. Anyone with a computer that is connected to the Internet or other communications network may type in the Internet protocol address of the microscope and access and view live images or images stored in the memory of the microscope. The controller/processor 44 is also preferably encoded with a viewer program which permits remote computers to control the microscope to record and store additional magnified images and to perform other control functions.

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A microscope comprising:
a stand;
a stage supported by the stand for holding a specimen to be viewed;
a lens assembly for providing a magnified view of the specimen on the stage; and
image capture circuitry for creating an image signal representative of the magnified view of the specimen, the image capture circuitry including memory resident within the microscope for storing the image signal for subsequent retrieval.

2. The microscope as set forth in claim 1, wherein the memory comprises a removable memory card and a memory slot for removably receiving the memory card.

3. The microscope as set forth in claim 2, wherein the memory card and the memory slot are Compact Flash memory devices.

4. The microscope as set forth in claim 2, wherein the memory card and the memory slot are Secured Digital memory devices.

5. The microscope as set forth in claim 1, further including a light source assembly for illuminating the stage, the light source assembly including at least one LED.

6. The microscope as set forth in claim 1, the image capture circuitry further including an image sensor coupled with the lens assembly for creating the image signal representative of the magnified view of the specimen, a controller coupled with the image sensor for receiving the image signal and storing it in the memory, controls for controlling function of the controller and a plurality of outputs coupled with the controller for outputting signals associated with the image signal.

7. The microscope as set forth in claim 1, the lens assembly including a plurality of objective lenses and an eye piece lens.

8. The microscope as set forth in claim 6, wherein the outputs include an analog output port for delivering an analog signal associated with the image signal to a TV monitor, and a digital output port for delivering a digital signal associated with the image signal to a computer monitor.

9. The microscope as set forth in claim 8, wherein the digital signal is a universal serial bus (USB) signal.

10. A microscope comprising:
a stand having a base and an upstanding arm;
a stage supported on the arm for holding a specimen to be viewed;
at least one objective lens mounted on the arm above the stage for magnifying the specimen;
an eyepiece lens coupled with the objective lens for further magnifying the specimen;
a light source positioned in the base below the stage for illuminating the specimen on the stage; and
image capture circuitry for creating an image signal representative of the magnified view of the specimen, the image capture circuitry including an image sensor for creating the image signal, a computing device coupled with the image sensor for receiving the image signal, and memory resident within the microscope coupled with the controller for storing the image signal for subsequent retrieval, the computing device having an Internet protocol address that permits the computing device to be addressed by remote computers via a communications network so that the remote computers may access and view the image signal.

11. The microscope as set forth in claim 10, wherein the memory comprises a removable memory card and a memory slot for removably receiving the memory card.

12. The microscope as set forth in claim 11, wherein the memory card and the memory slot are Compact Flash memory devices.

13. The microscope as set forth in claim 11, wherein the memory card and the memory slot are Secured Digital memory devices.

14. The microscope as set forth in claim 10, wherein the communications network is the Internet.

15. A video microscope comprising:
a base;
an elongated flexible neck coupled with the base;
a camera mounted on the neck for capturing an image of a specimen and for creating a corresponding image signal; and
image capture circuitry coupled with the camera for receiving the image signal, the image capture circuitry including memory resident within the microscope for storing the image signal for subsequent retrieval.

16. The video microscope as set forth in claim 15, wherein the memory comprises a removable memory card and a memory slot for removably receiving the memory card.

17. The video microscope as set forth in claim 16, wherein the memory card and the memory slot are Compact Flash memory devices.

18. The video microscope as set forth in claim 16, wherein the memory card and the memory slot are Secured Digital memory devices.

19. The video microscope as set forth in claim 15 wherein the image capture circuitry further includes a computing device having an Internet protocol address that permits the computing device to be accessed by remote computers via a communications network.

20. A microscope comprising:
a camera for capturing an image of a specimen and for creating a corresponding image signal;
a computing device resident within the microscope coupled with the camera and having its own Internet protocol address so that remote computers may access the computing device within the microscope via a communications network and view the image without requiring the microscope to be attached to a computer external to the microscope.

21. The microscope as set forth in claim 20, wherein the communications network is the Internet.

22. The microscope as set forth in claim 1, wherein the stand includes a base, and wherein the memory is positioned within the base.

23. The microscope as set forth in claim 10, wherein the memory is positioned within the base.

24. The microscope as set forth in claim 15, wherein the memory is positioned within the base.

25. The microscope as set forth in claim 20, further including a base for supporting the camera, wherein the computing device is positioned within the base.
